(19) United States
(12) Patent Application Publication
(10) Pub. No.: US 2024/0078426 A1
(43) Pub. Date: Mar. 7, 2024

(54) SYSTEM, APPARATUS AND PROCESSING METHOD SUITABLE FOR PREDICTIVE BASED ANALYSIS OF A STRUCTURE

(71) Applicant: PETROLIAM NASIONAL BERHAD (PETRONAS), Kuala Lumpur (MY)

(72) Inventors: M Nazmi B M ALI, Kuala Lumpur (MY); Mohd Hisham Bin ABU BAKAR, Kuala Lumpur (MY); Ahmad Sirwan B M TUSELIM, Kuala Lumpur (MY); M Zaid B KAMARDIN, Kuala Lumpur (MY); Khairul Anwar B A SAMAD, Kuala Lumpur (MY); Sani B SULAIMAN, Kuala Lumpur (MY); Nurazzura BT M FUZI, Kuala Lumpur (MY); M Afiq B M SUHOT, Kuala Lumpur (MY); Said Jadid ABDULKADIR, Kuala Lumpur (MY)

(21) Appl. No.: 18/272,525

(22) PCT Filed: Jan. 13, 2022
(86) PCT No.: PCT/MY2022/050002

§ 371 Date: Jul. 14, 2023

(30) Foreign Application Priority Data
Jan. 15, 2021 (MY) PI2021000243

(51) Int. Cl. G06N 3/08

(52) U.S. Cl. CPC G06N 3/08

(57) ABSTRACT

There is provided an apparatus which can include a first module and a second module coupled to the first module. The first module can be configured to receive at least one input signal and/or generate at least one input signal. The input signal can be associated with at least one operating parameter and/or at least one target variable, associable with a structure (e.g., a pipeline). The second module can be configured to process the input signal by manner of data cleaning, data wrangling and/or data merging, to produce at least one output signal communicable for further processing (e.g., Machine-Learning based processing).

### REFERENCE TO RELATED APPLICATIONS

The present application is a U.S. national phase of PCT International Patent Application No. PCT/MY2022/050002, filed Jan. 13, 2022, which claims priority to Malaysian Patent Application No. PI2021000243, filed Jan. 15, 2021, both of which are incorporated herein by reference in their entireties.

### FIELD OF INVENTION

The present disclosure generally relates to a system suitable for analyzing a structure such as a pipeline. Specifically, the present disclosure can generally relate to, for example, predictive based analysis of a pipeline. The present disclosure further relates to one or both of an apparatus and a processing method associable to the system.

### BACKGROUND

In petroleum engineering industry, it is generally useful to anticipate/identify possibility of issue(s) in connection with, for example, a pipeline structure (i.e., simply referred to as a “pipeline”).

An example of an issue is pipeline corrosion.

Currently, techniques such as Intelligent Pigging (IP) inspection, In-line inspection (ILI), Field measurement and/or corrosion modelling are used.

However, the present disclosure contemplates that IP inspection and/or ILI need not necessarily be cost effective and/or provide instantaneous/real-time indication of possible corrosion. Additionally, Field measurement may be limited in the sense that such measurement could be limited in area/range of detection and/or could be labor intensive. Moreover, corrosion modeling need not necessarily be comprehensive and/or reliable.

Therefore, the present disclosure contemplates that current techniques need not necessarily detect issue(s) associated with, for example, a pipeline in an efficient manner, user friendly manner and/or a suitably comprehensive manner.

The present disclosure contemplates that there is a need for improvement in regard to the aforementioned anticipation/identification of possible issue(s) in association with, for example, a pipeline.

### SUMMARY OF THE INVENTION

In accordance with an aspect of the disclosure, there is provided an apparatus which can include a first module and a second module. The first and second modules can be coupled.

The first module can be configured to one or both of receive and generate one or more input signals (i.e., at least one of receive at least one input signal and generate at least one input signal). The input signal(s) can be associated with one or both of one or more operating parameters associated with a structure (e.g., a pipeline) and one or more target variables associated with a structure (e.g., a pipeline) (i.e., at least one of: at least one operating parameter and at least one target variable, associable with a structure).

The second module can be configured to process the input signal(s) by manner of any one of, or any combination of, the following:
data cleaning;
data wrangling; and
data merging,
to produce one or more output signals which can be communicated for further processing.

That is, the second module can, for example be configured to process the input signal(s) by manner of data cleaning, data wrangling and/or data merging (i.e., at least one of data cleaning, data wrangling and data merging) to produce at least one output signal which can be communicated for further processing.

In one embodiment, the apparatus can further include a third module which can, for example, be coupled to the second module. The output signal(s) can be communicated to the third module from the second module for further transmission from the apparatus to at least one device coupled to the apparatus. The output signal can, for example, be received by the device for machine-learning based processing. For example, the output signal(s) can be communicated for further processing by manner of machine-learning (ML) based processing to generate at least one ML model. The ML based processing can include/be associated with a data normalization stage, a data splitting stage and/or a model training stage (i.e., at least one of a data normalization stage, a data splitting stage and a model training stage). In accordance with an embodiment of the disclosure, during the data splitting stage, a training dataset and/or a testing dataset can be obtained.

In accordance with another aspect of the disclosure, there is provided a processing method which can be suitable for generating at least one output signal communicable for machine-learning (ML) based processing to derive at least one ML model.

The method can include generating and/or receiving one or more input signals (i.e., at least one of generating and receiving at least one input signal). The input signal(s) can be associated with one or both of at least one operating parameter associated with a structure and at least one target variable associated with a structure (i.e., at least one of: at least one operating parameter; and at least one target variable, associable with a structure). The structure can, for example, correspond to a pipeline.

The method can further include processing the input signal(s) by manner of any one of, or any combination of, the following:
data cleaning;
data wrangling; and
data merging,
to produce one or more output signals (i.e., at least one of data cleaning, data wrangling and data merging to produce at least one output signal).

The method can yet further include communicating the one output signal(s) for machine-learning based processing to derive at least one ML model.

### BRIEF DESCRIPTION OF THE DRAWINGS

Embodiments of the disclosure are described hereinafter with reference to the following drawings, in which:

FIG. 1 shows a system which can include at least one apparatus and, optionally, at least one device, according to an embodiment of the disclosure;

FIG. 2 shows the apparatus of FIG. 1 in further detail, according to an embodiment of the disclosure;

FIG. 3 shows the device of FIG. 1 in further detail, according to an embodiment of the disclosure;

FIG. 4 shows an example of a web-based visualization dashboard in association with the device of FIG. 2, according to an embodiment of the disclosure;

FIG. 5 shows a processing method in association with the system of FIG. 1, according to an embodiment of the disclosure.

### DETAILED DESCRIPTION

The present disclosure contemplates that in connection with the aforementioned anticipation/identification of possible issue(s) in association with a structure (e.g., pipeline), a robust prediction model (e.g., a robust pipeline corrosion prediction model) should be considered. The present disclosure further contemplates the possibility of erroneous readings which could be generated by limited sensors carried by the structure (e.g., carried along the pipeline). In this regard, the present disclosure contemplates the possibility of filtering and pre-processing (e.g., via a one-Dimension imputation approach) such sensor readings to generate more complete structural operating parameter(s) (e.g., for every centimeter) along the structure profile.

In one example scenario, the generated operating parameter(s) can be matched with respective log-distance in historic In-Line Inspection (ILI) reports to create a machine learning data frame for corrosion depth (%) and length (mm). The data frame can be used to train a machine learning (ML) model using, for example, a one-dimensional convolutional neural network (1D-CNN) for prediction (e.g., corrosion prediction).

The present disclosure further contemplates that, in an example scenario, a predictive analytics tool can be useful for, for example, detecting/identifying internal and external corrosion in a pipeline using big data with machine learning (ML) capability based on pipeline operating data to predict real-time corrosion in the pipeline. For example, a ML model can be useful for predicting internal corrosion for a dry gas & export crude pipeline system. The prediction outcome(s) can, for example, be in the form of corrosion geometry (e.g., depth & length), which can facilitate immediate and/or future integrity calculation in connection with a pipeline.

It is contemplated that a ML model can possibly reduce and/or eliminate dependency on conventional techniques such as IP inspection and/or ILI. With big data & machine learning capability, continuous prediction improvement can be realized as a ML model can be capable of demonstrating learning with increased data samples (e.g., more pipeline data are ingested & validated in association with a ML model). It is further contemplated that a ML model can be adapted for one or more other applications (e.g., in connection with other pipeline(s) in upstream transporting where wet gas, condensation etc., could cause internal corrosion). A ML model can, for example, correspond to the aforementioned (robust) prediction model.

The foregoing will be discussed in further detail with reference to FIG. 1 to FIG. 5 hereinafter.

Referring to FIG. 1, a system 100 is shown, according to an embodiment of the disclosure. The system 100 can be suitable for analyzing a structure such as a pipeline. For example, the system 100 can be suitable for predictive based analysis of a pipeline.

The system 100 can include one or more apparatuses 102 and, optionally, one or both of at least one device 104 and a communication network 106.

The apparatus(es) 102 can be coupled to the device(s) 104. Specifically, the apparatus(es) 102 can, for example, be coupled to the device(s) 104 via the communication network 106.

In one embodiment, the apparatus(es) 102 can be coupled to the communication network 106 and the device(s) 104 can be coupled to the communication network 106. Coupling can be by manner of one or both of wired coupling and wireless coupling. The apparatus(es) 102 can, in general, be configured to communicate with the device(s) 104 via the communication network 106, according to an embodiment of the disclosure.

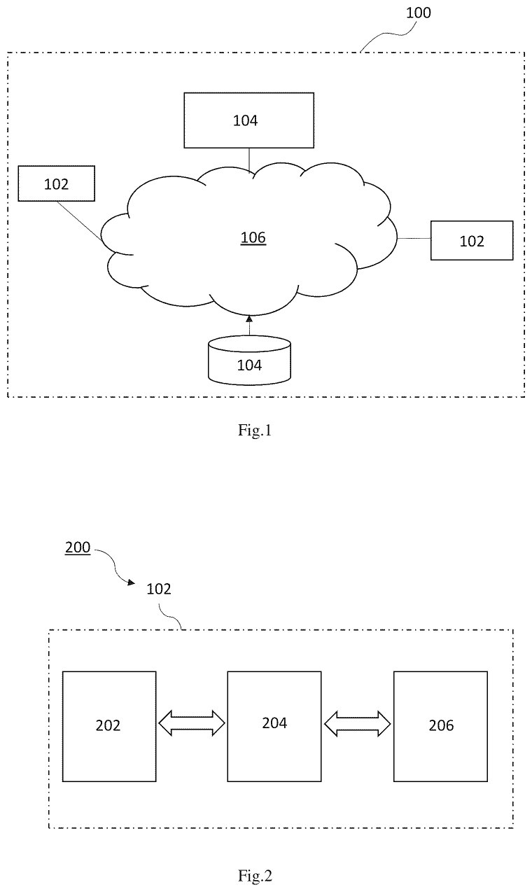

The apparatus(es) 102 can, for example, correspond to one or more computers (e.g., laptops, desktop computers and/or electronic mobile devices having computing capabilities such as Smartphones and electronic tablets). The apparatus(es) 102 can, in one embodiment, include one or more processors (not shown) which can be configured to perform one or more processing tasks which can, for example, include one or more data preprocessing-based tasks. Generally, the apparatus(es) 102 can be configured to generate and/or receive one or more input signals and process the input signal(s) in a manner so as to produce one or more output signals. The apparatus(es) 102 will be discussed later in further detail with reference to FIG. 2, according to an embodiment of the disclosure.

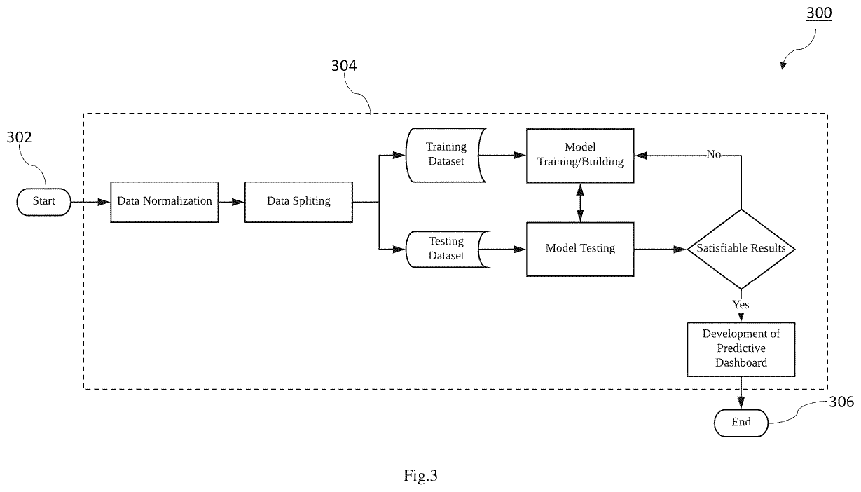

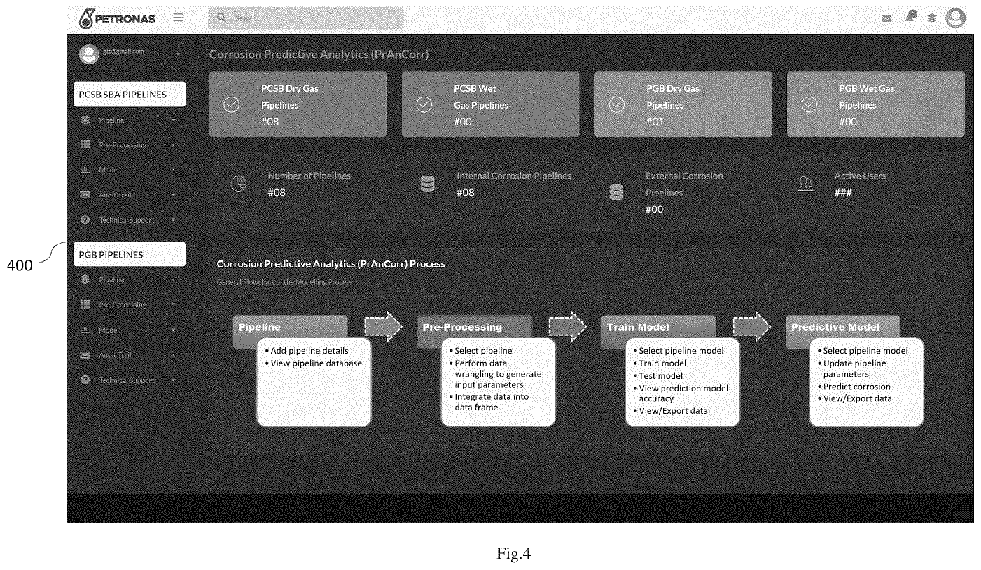

The device(s) 104 can, for example, correspond to one or more host devices (e.g., one or more computers or one or more databases). A host device can, for example, be configured to host/carry a platform (software and/or hardware platform) configured to perform one or more processing tasks which can, for example, include learning-based processing tasks (e.g., machine-learning based processing). The device(s) 104 can be configured to receive the output signal(s) for processing (e.g., machine-learning) to produce one or more prediction signals. The prediction signal(s) can, for example, correspond to one or more prediction models. The prediction signal(s) can be communicated from the device(s) 104 and received by, for example, the apparatus(es) 102. The device(s) 104 will be discussed later in further detail with reference to FIG. 3, according to an embodiment of the disclosure.

The communication network 106 can, for example, correspond to an Internet communication network. Communication (i.e., between the apparatus(es) 102 and the device(s) 104) via the communication network 106 can be by manner of one or both of wired communication and wireless communication.

The aforementioned apparatus(es) 102 will be discussed in further detail with reference to FIG. 2 hereinafter.

Referring to FIG. 2, an apparatus 102 is shown in further detail in the context of an exemplary implementation 200, according to an embodiment of the disclosure.

In the exemplary implementation 200, the apparatus 102 can carry a first module 202, a second module 204 and a third module 206. The first module 202 can be coupled to one or both of the second module 204 and the third module 206. The second module 204 can be coupled to one or both of the first module 202 and the third module 206. The third module 206 can be coupled to one or both of the first module 202 and the second module 204. Coupling between the first, second and/or third modules 202/204/206 can, for example, be by manner of one or both of wired coupling and wireless coupling. Each of the first, second and third modules 202/204/206 can correspond to one or both of a hardware-based module and a software-based module, according to an embodiment of the disclosure.

In one example, the first module 202 can correspond to a hardware-based receiver which can be configured to receive the input signal(s). In another example, the first module 202 can correspond to a graphics user interface (e.g., displayable on a screen, which is not shown, of the apparatus(es) 102) usable by a user (not shown) for generating one or more command signals which can, in turn, generate the input signal(s). Generally, the first module 202 can be associated with data acquisition (i.e., acquired data corresponding to the input signal(s)). This will be discussed later in further detail.

The second module 204 can, for example, correspond to a hardware-based processor which can be configured to perform the aforementioned data preprocessing-based task(s) based on the input signal(s) to produce one or more output signals.

The third module 206 can correspond to a hardware-based transmitter which can be configured to transmit the output signal(s).

The present disclosure contemplates the possibility that the first and third modules 202/206 can be an integrated software-based transceiver module (e.g., an electronic part which can carry a software program/algorithm in association with receiving and transmitting functions/an electronic module programmed to perform the functions of receiving and transmitting). Moreover, it is appreciable that the aforementioned graphics user interface can be considered to be software-based.

Earlier mentioned, the first module 202 can be associated with data acquisition. Additionally, the second module 204 can, for example, correspond to a hardware-based processor which can be configured to perform one or more data preprocessing-based tasks on the received and/or generated input signal(s) to produce one or more output signals.

Data acquisition can, for example, be based on one or both of hypothesizing and obtaining data from one or more data providers, in accordance with an embodiment of the disclosure.

In regard to hypothesizing, Group Technical Solutions (GTS) domain expert knowledge, creativity and problem familiarity can be used/considered. In this manner data which can be considered to be relevant can be obtained.

In regard to obtaining data from data provider(s), a list of one or more potential data providers can be generated. For example, a shortlist of one or more sources that provide data type hypothesized by GTS domain experts can be generated and/or created.

Based on hypothesizing and/or obtaining data from data provider(s), one or more operating parameters in association with a structure (e.g., a pipeline) can be identified. The structure (e.g., a pipeline) can be associated with (e.g., monitored by) a monitoring system (e.g., a pipeline monitoring system (PMS)). The operating parameter(s) can be considered to be one or both of input variable(s) and target variable(s).

In one example scenario, one or more pipeline operating parameters (e.g., twelve pipeline operating parameters) can be identified as input variables by one or more domain experts:
1. Pipeline Age
2. Corrosion Inhibitor availability, %
3. Operational Pigging, compliance %
4. H2S content, ppm
5. Moisture content/water cut, lb/mmsc or %
6. Pressure profile, barg
7. Temperature profile, barg
8. Water holdup profile, fraction
9. Total liquid holdup profile, fraction
10. Partial CO2 pressure profile, mole %
11. Superficial gas velocity profile, m/s
12. Superficial liquid velocity profile, m/s

Additionally, in one example scenario, one or more parameters can be identified as target variable(s):
1. Corrosion Depth (%)
2. Corrosion Length (mm)

The data preprocessing-based task(s) can include any one of, or any combination of, the following:
A) Data cleaning
B) Data wrangling
C) Data merging

Data cleaning, Data wrangling and Data merging will now be discussed in further detail in turn hereinafter.

In regard to Data cleaning, the present disclosure contemplates that undesirable data (e.g., corrupt or inaccurate records) can be detected and corrected/removed from acquired data (e.g., record set, table and/or database). For example, incorrect, inaccurate and/or irrelevant data from acquired data can be identified and, thereafter, replaced, modified or deleted (e.g., deleting data considered to be coarse or dirty).

In regard to Data wrangling, the present disclosure contemplates that one or both of an extrapolation process and an interpolation process can be performed. The extrapolation process and/or the interpolation process can be performed to generate data frames that can match respective log-distance reported in a pipeline log-distance report (e.g., based on in-line inspection (ILI), using ILI tools). The present disclosure contemplates that Data wrangling may be necessary if there is a mismatch in parameter readings (of data) via the PMS and pipeline log-distance per ILI reports (e.g., generated via the ILI tools).

In one example, the extrapolation process can be performed for extrapolation of missing values due to one or more error readings. The present disclosure contemplates that extrapolation can be a type of estimation, beyond the original observation range, of the value of a variable based on its relationship with another variable. The present disclosure further contemplates that a mean replication approach can be applied in the extrapolation process for error reading(s) of PMS value(s) which can be identified by domain experts from GTS.

In one example, the interpolation process can be performed for interpolation of missing values due to unavailability of, for example, sensor readings in a PMS. The present disclosure contemplates that interpolation can be a type of estimation which can be associated with a method of constructing new data points within the range of a discrete set of known data points. The present disclosure further contemplates that a one-dimensional interpolation can be applied for PMS operating parameter(s). Moreover, the interpolation process may be required as only certain (e.g., selected) points within a pipeline have sensor readings.

In regard to Data merging, the present disclosure contemplates that one or more merging-based processing tasks can be performed. The merging-based processing task(s) can include a first sub-process and a second sub-process, in accordance with an embodiment of the disclosure.

In one example, the first sub-process can be associated with the process of merging one or more structure (e.g., pipeline) operating parameters data frames with one or more ILI report data frames. For example, a pipeline operating parameters data frame can be merged with an ILI report data frame. The present disclosure contemplates that an imputation process can be used to generate respective pipeline operating parameters data frame(s) which can be sorted and matched with respective log-distance from the ILI report data frame(s).

In one example, the second sub-process can be associated with the process of stacking data frames for a structure (e.g., a pipeline) with multiple ILI report data frames. For example, there can be two ILI reports (and therefore two ILI report data frames), and both ILI report data frames can be stacked together to generate a single data frame. Such a single data frame can correspond to the aforementioned output signal(s).

In the above manner (i.e., Data acquisition, Data cleaning, Data wrangling and/or Data merging), one or more output signals can be generated. In one embodiment, by manner of the above-mentioned Data acquisition, Data cleaning, Data wrangling and Data merging, one or more output signals can be generated.

The output signal(s) can be communicated from the apparatus 102 (e.g., via third module 206) to the device(s) 104.

In view of the foregoing, it is appreciable that the present disclosure generally contemplates an apparatus 102 which can include a first module 202 and a second module 204. The first and second modules 202/204 can be coupled.

The first module 202 can be configured to one or both of receive and generate at one or more input signals (i.e., at least one of receive at least one input signal and generate at least one input signal). The input signal(s) can be associated with one or both of one or more operating parameters associated with a structure (e.g., a pipeline) and one or more target variables associated with a structure (e.g., a pipeline) (i.e., at least one of: at least one operating parameter and at least one target variable, associable with a structure).

The second module 204 can be configured to process the input signal(s) by manner of any one of, or any combination of, the following:
data cleaning;
data wrangling; and
data merging,
to produce one or more output signals which can be communicated for further processing.

That is, the second module 204 can, for example be configured to process the input signal(s) by manner of data cleaning, data wrangling and/or data merging (i.e., at least one of data cleaning, data wrangling and data merging) to produce at least one output signal which can be communicated for further processing.

In one embodiment, the apparatus 102 can further include a third module 206 which can, for example, be coupled to the second module 204.

The output signal(s) can be communicated to the third module 206 from the second module 204 for further transmission from the apparatus 102 to at least one device 104 coupled to the apparatus 102.

The output signal can, for example, be received by the device 104 for machine-learning based processing. For example, the output signal(s) can be communicated for further processing by manner of machine-learning (ML) based processing to generate at least one ML model. A ML model can, for example, correspond to a prediction model.

Earlier discussed, the device(s) 104 can, for example, correspond to one or more host devices (e.g., one or more computers or one or more databases). A host device can, for example, be configured to host/carry a platform (software and/or hardware platform) configured to perform one or more processing tasks which can, for example, include learning-based processing tasks (e.g., machine-learning). The device(s) 104 can be configured to receive the output signal(s) for processing (e.g., machine-learning) to produce one or more prediction signals. The prediction signal(s) can, for example, correspond to one or more prediction models (i.e., ML model(s)).

The device(s) 104 will be discussed in further detail with reference to FIG. 3, in accordance with an embodiment of the disclosure, hereinafter.

Referring to FIG. 3, a block diagram 300 in association with a device 104 is shown, in accordance with an embodiment of the disclosure. Specifically, the block diagram 300 can, for example, be representative of the aforementioned device(s) 104, in accordance with an embodiment of the disclosure.

The block diagram 300 can, for example, include any one of an input portion 302, a processing portion 304 and an output portion 306, or any combination thereof.

In one embodiment, the block diagram 300 can include an input portion 302, a processing portion 304 and an output portion 306.

The input portion 302 can be coupled to the processing portion 304. The processing portion 304 can be coupled to the output portion 306.

In one embodiment, the input portion 302 can correspond to an electronic hardware-based receiver which can be configured to receive the output signal(s) communicated from the apparatus(es) 102. The output signal(s) can be further communicated from the input portion 302 to the processing portion 304.

In one embodiment, the processing portion 304 can correspond to an algorithm (e.g., a machine learning algorithm) capable of performing machine learning based on the received output signal(s). In this regard, the processing portion 304 can be considered to be software-based, in accordance with an embodiment of the disclosure. Based on the output signal(s), the processing portion 304 can be configured to generate one or more prediction signals. The prediction signal(s) can be further communicated from the processing portion 304 to the output portion 306. Machine learning can, for example, be based on a neural network-based machine learning model.

In one embodiment, the output portion 306 can correspond to an electronic hardware-based transmitter which can be configured to transmit the prediction signal(s). The prediction signal(s) can be further communicated from the output portion 306 to, for example, the apparatus(es) 102.

Moreover, the present disclosure contemplates the possibility that the input and output portions 302/306 can be an integrated software-based transceiver module (e.g., an electronic part which can carry a software program/algorithm in association with receiving and transmitting functions/an electronic module programmed to perform the functions of receiving and transmitting). Furthermore, the processing portion 304 can, in one embodiment, correspond to a hardware-based processor (e.g., a microprocessor) carrying a machine learning algorithm.

Coupling between the input, processing and/or output portions 302/304/306 can, for example, be by manner of one or both of wired coupling and wireless coupling. Each of the input, processing and/or output portions 302/304/306 can correspond to one or both of a hardware-based module and a software-based module, according to an embodiment of the disclosure.

The input portion 302, the processing portion 304 and the output portion 306 will now be discussed in further detail in turn hereinafter.

The input portion 302 (labeled as “Start” in FIG. 3) can receive the output signal(s) and communicate the received output signal(s) to the processing portion 304 for further processing, in accordance with an embodiment of the disclosure.

The processing portion 304 can include/be associated with one or more of the following main/substantive stages, or any combination (of stages) thereof:
I. Data normalization stage (labeled as “Data Normalization” in FIG. 3)
II. Data splitting stage (labeled as “Data Splitting” in FIG. 3)
III. Model training stage (labeled as “Model Training/Building” in FIG. 3)
IV. Model testing and validation stage (labeled as “Model Testing” in FIG. 3)
V. Model visualization stage (labeled as “Development of Predictive Dashboard” in FIG. 3)

The above stages I. to V. will be discussed in turn, in further detail, hereinafter.

I. Data Normalization Stage

In regard to the Data normalization stage, the present disclosure contemplates that numeric value(s) in a dataset (i.e., which can, for example, be associated with the aforementioned data frame(s)) can be changed/modified/transformed (i.e., by manner or normalization) without distorting differences in the ranges of values or losing information. For example, the mean of data can be set to “0” and the standard deviation can be set to “1”. The present disclosure contemplates that normalization can be applied feature-wise using Min-Max normalization. Data range can be rescaled to/based on “0” to “1”.

II. Data Splitting Stage

In regard to the Data splitting stage, the present disclosure contemplates that a “train-test” split technique can be considered. The train-test split is a technique for evaluating performance of a machine learning algorithm. It can be used for classification or regression problems and can be used for any supervised learning algorithm.

The procedure (i.e., in association with train-test split) can involve taking a dataset and dividing it into two subsets which can include, for example, a first subset and a second subset.

The first subset can be used to fit a model (i.e., machine learning model) and can be referred to as a training dataset (i.e., labeled as “Training Dataset” in FIG. 3).

The second subset is not used for training the model. Instead, the input element of the dataset (i.e., in association with the second subset) is provided to the model, then predictions are made and compared to the expected values. The second subset can be referred to as a test dataset (i.e., labeled as “Testing Dataset” in FIG. 3).

In one embodiment, a random split ratio of 70%: 30% in respect of the training dataset and test dataset can be applied respectively (i.e., 70% for the training dataset and 30% for the test dataset).

III. Model Training Stage

In regard to the model training stage, the present disclosure contemplates that a Machine-Learning (ML) algorithm can be provided with training data (i.e., based on the aforementioned Training Dataset) for the purpose of learning (i.e., learning/training process) to derive/generate one or more ML models. Appreciably, the term ML model can refer to a model artifact that is created by such learning/training process. It is contemplated that the training data can contain a target or a target attribute. Specifically, it is contemplated that, based on the ML algorithm, one or more patterns can be established and the pattern(s) can map input data attribute(s) to desired target(s). The pattern(s) can, for example, correspond to the aforementioned prediction signal(s). Moreover, the present disclosure contemplates that one or more ML models can be generated/established based on the pattern(s) (e.g., the pattern(s) can be captured by such a generated/established ML model).

IV. Model Testing and Validation Stage

In regard to the model testing and validation stage, the present disclosure contemplates that new data (e.g., data not previously used/not part or associated with the aforementioned Training Dataset) can be used for testing/validation. Specifically, it is contemplated that such new data can be useful for estimating quality of generalization. However, as such new data can be considered to be associated with “future instances” and would therefore be associated with unknown target values. Therefore, estimation of quality of generalization should not be based solely on such new data. It is contemplated that already known data can be used as proxy for future data. The present disclosure further contemplates that model evaluation using the same data that was used for training may not necessarily be useful as model(s) that can “remember” the training data could potentially be unduly rewarded (i.e., as opposed to generalizing).

The present disclosure contemplates that, in accordance with an embodiment of the disclosure, performance (e.g., quality of generalization) of model(s) can be evaluated based on any one, or any combination, of: R² (coefficient of determination), MAPE (Mean Absolute Percentage Error), RMSE (Root Mean Square Error) and MAE (Mean Absolutely Error) as shown in Table 1 below:

TABLE 1
Performance measurement metrics.

| Metric | Description | Range | | | |
|---|---|---|---|---|---|
| R² | The coefficient of | [0%~100%]-can also be | | | |
| | determination, the | represented as percentages. | | | |
| | percent | Higher percentage would be more ideal. | | | |
| | variation in one | 0~20% | 20~49% | 50%~70% | >70% |
| | variable | none | weak | moderate | Strong |
| | explained by | | | | |
| | the other | | | | |
| | variable. A | | | | |
| | high R² | | | | |
| | indicates strong | | | | |
| | positive linear | | | | |
| | relationship i.e. | | | | |
| | when one | | | | |
| | variable increases, | | | | |
| | the other | | | | |
| | increases-a | | | | |
| | relationship that | | | | |
| | can/would | | | | |
| | be expected | | | | |
| | from a good | | | | |
| | model. | | | | |
| RMSE | Root Mean Square | Depends on the range of | | | |
| | Error is | actual values. A lower value | | | |
| | the standard | would be more ideal. | | | |
| | deviation of the | | | | |
| | residuals. | | | | |
| | Residuals are | | | | |
| | a measure of | | | | |
| | how far from | | | | |
| | the actual values | | | | |
| | the data points are. | | | | |
| | RMSE is a | | | | |
| | measure of | | | | |
| | how spread | | | | |
| | out these | | | | |
| | residuals are. | | | | |
| MAE | Mean Absolute | | | | |
| | Error measures | | | | |
| | the average | | | | |
| | magnitude of | | | | |
| | the errors | | | | |
| | in a set of | | | | |
| | predictions, | | | | |
| | without | | | | |
| | considering | | | | |
| | their direction. | | | | |
| MAPE | The mean absolute | A lower percentage would be more ideal. | | | |
| | percentage error | <10% | 10%~20% | 20~0% | >50% |
| | (MAPE) is | ex- | good | rea- | in- |
| | the mean or | cellent | | sonable | accurate |
| | average of | | | | |
| | the absolute | | | | |
| | percentage | | | | |
| | errors of | | | | |
| | forecasts. Error is | | | | |
| | defined as | | | | |
| | actual or | | | | |
| | observed | | | | |
| | value minus | | | | |
| | the forecasted | | | | |
| | value. | | | | |

V. Model Visualization Stage

In regard to the model visualization stage, the present disclosure contemplates that visualization can provide reason and logic to enable accountability and transparency in association with the aforementioned model(s). For example, a web-based visualization dashboard (e.g., a web-based application/program) can be developed for a machine learning model using programming language(s) such as Python based programming language and/or Hypertext Markup Language (HTML).

The output portion 306 (labeled as “End” in FIG. 3) can be configured to communicate the prediction signal(s) and/or signal(s) associated with/indicative of the ML model(s) from the device(s) 104.

FIG. 4 shows an example of a web-based visualization dashboard 400, in accordance with an embodiment of the disclosure.

In view of the foregoing, it is appreciable that the present disclosure can generally relate to a system 100 suitable for analyzing (e.g., by manner of the aforementioned data acquisition, data cleaning data wrangling and/or data merging to produce/generate the output signal(s) to produce/generate the prediction signal(s)) a structure such as a pipeline and generating one or more ML model(s) (e.g., predictive based analysis of a pipeline). The ML model(s) can correspond to the aforementioned prediction model(s) which can be useful for, for example, facilitating the identification/revelation of substantially instantaneous corrosion behavior in terms of defect(s) in geometry (e.g., depth and length) based on operating and pipeline process condition, according to an embodiment of the disclosure.

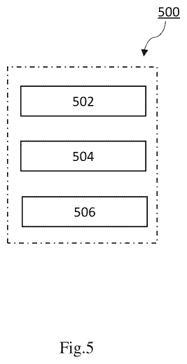

Referring to FIG. 5, a processing method 500 in association with the system 100 is shown, according to an embodiment of the disclosure.

The processing method 500 can include any one of an acquisition step 502, a processing step 504 and an output generating step 506, or any combination thereof.

With regard to the acquisition step 502, the aforementioned input signal(s) can be received and/or generated. As discussed earlier, the input signal(s) can be generated and/or received by the apparatus(es) 102 for processing, according to an embodiment of the disclosure.

With regard to the processing step 504, the input signal(s) can be processed (i.e., by the second module 204) in a manner so as to generate/produce one or more output signal(s), as discussed earlier with reference to FIG. 2, according to an embodiment of the disclosure.

With regard to the output step 506, the output signal(s) can be communicated to the device(s) 104 for further machine learning based processing in a manner as discussed with reference to FIG. 3, according to an embodiment of the disclosure.

In embodiment the method 500 can include a learning step wherein the output signal(s) can be received and processed by the device(s) 104 for further machine learning based processing in a manner as discussed with reference to FIG. 3, according to an embodiment of the disclosure.

In this regard, the present disclosure generally contemplates, in one embodiment, a processing method 500 which can be suitable for generating at least one output signal communicable for machine-learning (ML) based processing to derive at least one ML model.

The method 500 can include generating and/or receiving one or more input signals (i.e., at least one of generating and receiving at least one input signal). The input signal(s) can be associated with one or both of at least one operating parameter associated with a structure and at least one target variable associated with a structure (i.e., at least one of: at least one operating parameter; and at least one target variable, associable with a structure). The structure can, for example, correspond to a pipeline.

The method 500 can further include processing the input signal(s) by manner of any one of, or any combination of, the following:
data cleaning;
data wrangling; and
data merging,
to produce one or more output signals (i.e., at least one of data cleaning, data wrangling and data merging to produce at least one output signal).

The method 500 can yet further include communicating the one output signal(s) for machine-learning based processing to derive at least one ML model (i.e., one or more prediction models).

It should be further appreciated by the person skilled in the art that variations and combinations of features described above, not being alternatives or substitutes, may be combined to form yet further embodiments.

In one example, the device(s) 104 can be distinct (i.e., separate) from the apparatus(es) 102, according to an embodiment of the disclosure. In another embodiment, the device(s) 104 can be integral with the apparatus(es) 102 (e.g., a device 104 can be another module of an apparatus 102).

In another example, the device(s) 104 can be one or both of hardware-based (e.g., a host device, as discussed earlier) and software-based (e.g., an algorithm/a software module carried by an apparatus 102).

In yet another example, it is earlier mentioned that the output portion 306 can correspond to an electronic hardware-based transmitter which can be configured to transmit the prediction signal(s). It is contemplated that the output portion 306 can correspond to a display part (e.g., a display screen) which can be configured to display the prediction signal(s).

In yet a further example, the communication network 106 can be omitted, and the apparatus(es) 102 and the device(s) can be directly coupled (i.e., without the communication network 106) by manner of one or both of wired coupling and wireless coupling.

In yet another further example, the aforementioned model testing and validation stage and/or the model visualization stage can be omitted, in accordance with an embodiment of the disclosure.

In the foregoing manner, various embodiments of the disclosure are described for addressing at least one of the foregoing disadvantages. Such embodiments are intended to be encompassed by the following claims, and are not to be limited to specific forms or arrangements of parts so described and it will be apparent to one skilled in the art in view of this disclosure that numerous changes and/or modification can be made, which are also intended to be encompassed by the following claims.

What is claimed:

1. An apparatus comprising:
a first module configured to:
at least one of receive at least one input signal and generate at least one input signal, the input signal being associable with at least one of:
at least one operating parameter and at least one target variable, associable with a structure,
a second module coupled to the first module, the second module configured to process the input signal by manner of at least one of:
data cleaning,
data wrangling, and
data merging,
to produce at least one output signal communicable for further processing.

2. The apparatus of claim 1 further comprising:
a third module coupled to the second module, the output signal being communicable to the third module from the second module for further transmission from the apparatus to at least one device coupled to the apparatus,
wherein the output signal is receivable by the device for machine-learning based processing.

3. The apparatus of claim 1, wherein the at least one output signal is communicable for further processing by manner of machine-learning (ML) based processing to generate at least one ML model.

4. The apparatus of claim 3, wherein the ML based processing includes at least one of:
a data normalization stage;
a data splitting stage; and
a model training stage.

5. The apparatus of claim 4,
wherein during the data splitting stage, a training dataset and a testing dataset are obtained.

6. The apparatus of claim 1, wherein the structure corresponds to a pipeline.

7. A processing method suitable for generating at least one output signal communicable for machine-learning (ML) based processing to derive at least one ML model, the method comprising:
at least one of generating and receiving at least one input signal, the input signal being associable with at least one of:
at least one operating parameter; and
at least one target variable,
associable with a structure;
processing the at least one input signal by manner of at least one of:
data cleaning;
data wrangling; and
data merging,
to produce at least one output signal;
communicating the at least one output signal for machine-learning based processing to derive at least one ML model.
